(19) United States
(12) Patent Application Publication
(10) Pub. No.: US 2026/0120358 A1
(43) Pub. Date: Apr. 30, 2026

(54) METHOD FOR GENERATING MULTIMODAL TEXT, METHOD FOR ACQUIRING MULTIMODAL TEXT, DEVICE AND MEDIUM

(71) Applicant: Beijing Baidu Netcom Science Technology Co., Ltd., Beijing (CN)

(72) Inventors: Moye CHEN, Beijing (CN); Qifan WANG, Beijing (CN); Shiyue WANG, Beijing (CN); Hao LIU, Beijing (CN); Xinyan XIAO, Beijing (CN)

(21) Appl. No.: 19/003,766

(22) Filed: Dec. 27, 2024

(30) Foreign Application Priority Data
Jul. 16, 2024 (CN) 202410955241.5

(51) Int. Cl. G06T 11/60; G06F 16/535; G06F 40/40; G06N 3/042

(52) U.S. Cl. CPC G06T 11/60; G06F 16/535; G06F 40/40; G06N 3/042

(57) ABSTRACT

A method for generating a multimodal text, a method for acquiring a multimodal text, a device, and a medium are provided, which relate to the field of artificial intelligence technology, and in particular to technical fields of computer vision, deep learning and large models. The method for generating a multimodal text includes the follows: a text information corresponding to a prompt information is generated by a large language model based on the prompt information, in response to a multimodal text generation request including the prompt information being received; an image information corresponding to the text information is generated by the large language model based on the text information; and a multimodal text rendering tool is called by the large language model based on the text information and the image information to render the multimodal text including the text information and the image information.

This application claims the benefit of priority to Chinese Patent Application No. 202410955241.5, filed on Jul. 16, 2024. The entire contents of this application are hereby incorporated herein by reference.

### TECHNICAL FIELD

The present disclosure relates to a field of artificial intelligence technology, and in particular, to technical fields of computer vision, deep learning and large models. More specifically, the present disclosure provides a method for generating a multimodal text, a method for acquiring a multimodal text, a device, and a medium.

### BACKGROUND

With the development of computer technology and network technology, deep learning models are being used more and more widely and have made breakthrough progress in various fields. Among them, AI generated content (AIGC) is an important direction of deep learning.

### SUMMARY

The present disclosure provides a method for generating a multimodal text, a method for acquiring a multimodal text, a device, and a medium.

According to an aspect of the present disclosure, a method for generating a multimodal text is provided, including: generating, by a large language model, a text information corresponding to a prompt information based on the prompt information, in response to a multimodal text generation request including the prompt information being received; generating, by the large language model, an image information corresponding to the text information based on the text information; and calling, by the large language model, a multimodal text rendering tool based on the text information and the image information to render the multimodal text including the text information and the image information.

According to another aspect of the present disclosure, a method for acquiring a multimodal text is provided, including: transmitting a multimodal text generation request including a prompt information, in response to the prompt information being received; and presenting the multimodal text, in response to acquiring the multimodal text generated in response to the multimodal text generation request, where the multimodal text is generated by using the method for generating a multimodal text provided in the present disclosure.

According to another aspect of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to perform the method for generating a multimodal text or the method for acquiring a multimodal text provided in the present disclosure.

According to another aspect of the present disclosure, a non-transitory computer-readable storage medium having computer instructions stored therein is provided, where the computer instructions are configured to cause a computer to perform the method for generating a multimodal text or the method for acquiring a multimodal text provided in the present disclosure.

It should be understood that the content described in this section is not intended to identify key or important features of embodiments of the present disclosure, nor is it intended to limit the scope of the present disclosure. Other features of the present disclosure will become intelligible from the following description.

### BRIEF DESCRIPTION OF THE DRAWINGS

The accompanying drawings are used to better understand the present disclosure and do not constitute a limitation of the present disclosure, and in the drawings:

FIG. 1 shows a schematic diagram of an application scenario of a method and an apparatus for generating a multimodal text, and a method and an apparatus for acquiring a multimodal text according to an embodiment of the present disclosure;

FIG. 2 shows a flowchart of a method for generating a multimodal text according to an embodiment of the present disclosure;

FIG. 3 is a schematic diagram showing a principle of generating a text information according to an embodiment of the present disclosure;

FIG. 4 is a schematic diagram showing a principle of generating an image information according to an embodiment of the present disclosure;

FIG. 5 is a schematic diagram showing a principle of rendering a multimodal text according to an embodiment of the present disclosure;

FIG. 6 shows a diagram of an implementation architecture of a method for generating a multimodal text according to an embodiment of the present disclosure;

FIG. 7 shows a flowchart of a method for acquiring a multimodal text according to an embodiment of the present disclosure;

FIG. 8 shows a structural block diagram of an apparatus for generating a multimodal text according to an embodiment of the present disclosure;

FIG. 9 shows a structural block diagram of an apparatus for acquiring a multimodal text according to an embodiment of the present disclosure; and

FIG. 10 shows a block diagram of an electronic device for implementing a method for generating a multimodal text or a method for acquiring a multimodal text according to an embodiment of the present disclosure.

### DETAILED DESCRIPTION OF EMBODIMENTS

Exemplary embodiments of the present disclosure are described below in conjunction with the accompanying drawings, which include various details of embodiments of the present disclosure to facilitate understanding, but they should be considered as merely exemplary. Accordingly, those of ordinary skill in the art will recognize that various changes and modifications of embodiments described herein may be made without departing from the scope and spirit of the present disclosure. In addition, in the following description, descriptions of well-known functions and structures are omitted for clarity and conciseness.

The multimodal text has a special text format and is more colorful than the ordinary text. For example, the multimodal text may contain characters in various fonts, colors and sizes, as well as images, links, tables, videos and other elements to make the multimodal text more vivid and interesting.

With the development of deep learning technology, deep learning models are used as auxiliary tools for generating content in more and more scenarios, in order to improve the content generation efficiency. For example, the generative large language model may be used to generate a text, and the artificial intelligence (AI) painting tool may be used to generate an image. When it is necessary to generate a multimodal text, the large language model may be used to generate a text, an AI painting tool may be used to generate an image, and then an image editor such as Photoshop may be used to add the generated text to the generated image. That is, in the related art, when it is necessary to generate a multimodal text, it is possible to call various models or tools, which leads to technical problems of low efficiency and high cost of the multimodal text generation.

In order to solve the problems in the related art, the present disclosure provides a method for generating a multimodal text, a method for acquiring a multimodal text, an apparatus for generating a multimodal text, an apparatus for acquiring a multimodal text, a device, a medium and a program product. The following first describes an application scenario of the method and the apparatus provided in the present disclosure with reference to FIG. 1.

FIG. 1 shows a schematic diagram of an application scenario of a method for generating a multimodal text, a method for acquiring a multimodal text, an apparatus for generating a multimodal text, and an apparatus for acquiring a multimodal text according to an embodiment of the present disclosure.

As shown in FIG. 1, the application scenario 100 in this embodiment may include a user 110, a terminal device 120, and a server 130.

The terminal device 120 may be any electronic device that may provide an interactive interface, such as a smart phone, a tablet computer, a portable computer, or a desktop computer. The terminal device 120 may be communicatively connected to the server 130 via a network.

For example, a prompt information may be input into the terminal device 120 by the user 110 through an interactive interface provided by the terminal device 120, so as to prompt the terminal device 120 to generate a multimodal text based on the prompt information. For example, the terminal device 120 may be installed with content sharing client applications, content generation client applications, etc. The prompt information may be input on interactive interfaces of these client applications by the user 110, and these client applications may present the generated multimodal text to the user 110 based on the prompt information.

In an embodiment, after the terminal device 120 receives the prompt information input by the user 110, the terminal device 120 may, for example, transmit a multimodal text generation request 101 including the prompt information to the server 130. For example, in response to the multimodal text generation request 101 being received, the server 130 may generate a multimodal text 102 based on the prompt information in the multimodal text generation request 101, and then feed the generated multimodal text 102 back to the terminal device 120, so that the terminal device 120 presents the generated multimodal text 102 to the user 110.

In an embodiment, the server 130 may use a large language model to make decisions on the generation process of the multimodal text and call generation tools and rendering tools to generate the multimodal text based on the decisions. The generation tool may be the large language model for making decisions, or other deep learning models and the like, which is not limited in the present disclosure. In this way, the server 130 may achieve the automatic generation of the multimodal text.

In an embodiment, the server 130 may be a background management server that provides support for the operation of a client application installed in the terminal device 120. Alternatively, the server 130 may be a cloud server, also known as a cloud computing server or a cloud host, which is a host product in a cloud computing service system, so as to solve defaults of the difficult management and weak business scalability of an existing physical host and a VPS (virtual private server) service. Alternatively, the server 130 may be a server of a distributed system, or a server combined with a block-chain.

It should be noted that the method for generating a multimodal text provided in the present disclosure may be performed by the server 130. Accordingly, the apparatus for generating a multimodal text provided in the present disclosure may be provided in the server 130. The method for acquiring a multimodal text provided in the present disclosure may be performed by the terminal device 120. Accordingly, the apparatus for acquiring a multimodal text provided by the present disclosure may be provided in the terminal device 120.

It should be understood that the number and types of the terminal devices 120 and the servers 130 shown in FIG. 1 are merely illustrative. Depending on the implementation requirements, there may be any number and type of terminal devices 120 and servers 130.

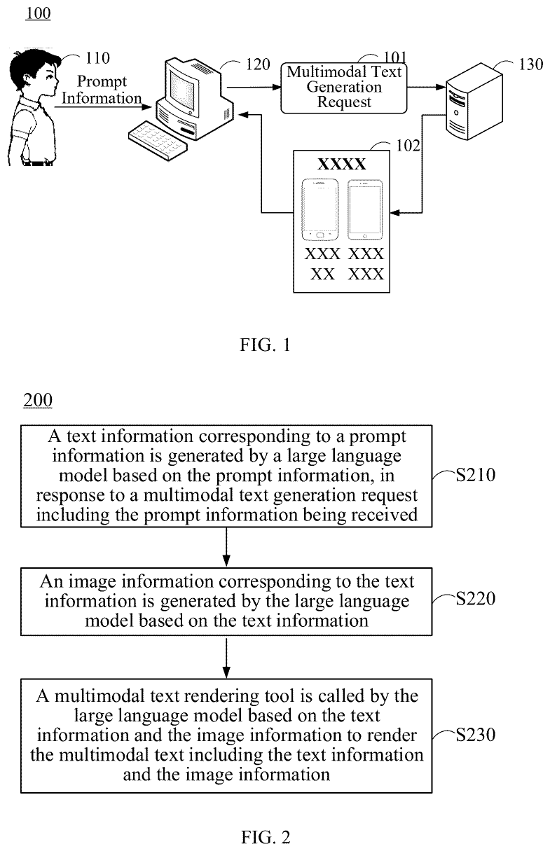

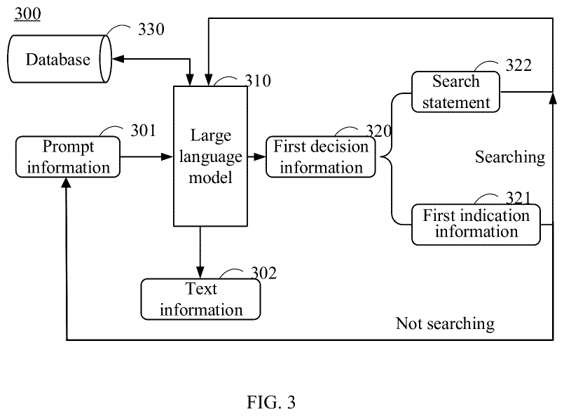

The following describes the method for generating a multimodal text provided in the present disclosure in detail with reference to FIG. 2 to FIG. 6.

FIG. 2 shows a flowchart of a method for generating a multimodal text according to an embodiment of the present disclosure.

As shown in FIG. 2, the method for generating a multimodal text 200 in this embodiment may include operations S210 to S230.

In operation S210, a text information corresponding to a prompt information is generated by a large language model based on the prompt information, in response to a multimodal text generation request including the prompt information being received.

According to embodiments of the present disclosure, after a multimodal text generation request is received, the server may parse the multimodal text generation request to obtain a prompt information (proposal) carried by the request, use the prompt information as an input of the large language model, and use a text output by the large language model as the text information. The large language model may be an existing large language model, etc., which is not limited in the present disclosure.

For example, the prompt information may be a subject information of the multimodal text to be generated, or may be a keyword of the multimodal text to be generated, etc., which is not limited in the present disclosure. For example, the prompt information may be “a mobile phone suitable for students”, “what are the interesting attractions in XX”, etc. The text information may be text content of the multimodal text to be generated. For example, the text information may be “the following mobile phones are suitable for students: mobile phone a, mobile phone b, mobile phone c, and mobile phone d”, “this is your first time visiting XX, and the recommended attractions are: attraction 1, attraction 2, and attraction 3”, etc., which is not limited in the present disclosure.

In operation S220, an image information corresponding to the text information is generated by the large language model based on the text information.

In an embodiment, the text information may serve as an input of the large language model, and the large language model searches an image database based on the text information to search for an image matched with the text information as the image information. A large number of images may be maintained in the image database. For example, based on the text information “the following mobile phones are suitable for students: mobile phone a, mobile phone b, mobile phone c, and mobile phone d”, the large language model may search for an image fig1 corresponding to mobile phone a, an image fig2 corresponding to mobile phone b, an image fig3 corresponding to mobile phone c, and an image fig4 corresponding to mobile phone d. In this embodiment, the image fig1, the image fig2, the image fig3 and the image fig4 may serve as the image information.

In this embodiment, the large language model is a pre-trained model that has the ability (such as function-calling) to connect to external tools. The external tools include an image database.

In an embodiment, the large language model is a pre-trained multimodal large language model. In this embodiment, the text information and the prompt information for generating an image may serve as an input of the large language model, and the large language model may generate the image information. For example, an input of the large language model may be “generate an image for the following text: the following mobile phones are suitable for students: mobile phone a, mobile phone b, mobile phone c, and mobile phone d”, etc., where the prompt information for generating an image is “generate an image for the following text”, etc., which is not limited in the present disclosure.

In operation S230, a multimodal text rendering tool is called by the large language model based on the text information and the image information, so as to render a multimodal text including the text information and the image information.

According to an embodiment of the present disclosure, the large language model is a pre-trained model that has the ability to connect to external tools, and the external tools include a multimodal text rendering tool. For example, the large language model may be provided with a calling interface for connecting with an external tool. The text information and the image information may serve as an input of the large language model, and a prompt information for calling a multimodal text rendering tool may also be input into the large language model. As such, the large language model may use the text information and the image information as input parameters of the calling interface of the multimodal text rendering tool based on the prompt information, and may output the multimodal text fed back by the calling interface. In operation S230, the large language model may act as an agent for calling the multimodal text rendering tool.

For example, Automatic multi-step Reasoning and Tool-use or a Function-Calling function may be used to enable the large language model to be connected to an external tool, which is not limited in the present disclosure.

The multimodal text rendering tool may be, for example, a Rich Text open source library or a wxParse plug-in, etc., which is not limited in the present disclosure.

According to embodiments of the present disclosure, the integrated and automated generation of multimodal text may be achieved based on the large language model. Compared with the technical solution of manually calling different models to generate a text and an image and then using an image editor to add the text to the image, the present disclosure improves the generation efficiency and automation level of the multimodal text. According to embodiments of the present disclosure, in the process of generating the multimodal text, a user is not required to learn calling techniques for different models or tools, but only needs to provide the prompt information. Therefore, the generation cost of the multimodal text may be reduced, which is conducive to the promotion of information in the form of multimodal text and improves the promotion degree of large language models.

The principle of generating a text information is further expanded and described below with reference to FIG. 3. FIG. 3 is a schematic diagram showing a principle of generating a text information according to an embodiment of the present disclosure.

In an embodiment, when generating the text information, for example, the large language model may be used to make a decision on whether to generate a text based on a search result. When the decision is made to generate the text based on the search result, the large language model performs a retrieval-augmented generation (RAG) task to generate the text based on the search result. In this way, the generated text information is integrated with the search result, which may improve the timeliness, accuracy and/or authenticity of the generated text information. This is because through the search, it is possible to determine a timely and real information which has not been learned by the large language model. In addition, by generating the text based on the search result, the diversity of the generated text information may be improved. This is because when the large language model is directly used to generate texts, the generated texts are usually highly similar to each other. By combining the search result to generate the text, the large language model may refer to knowledge it has not learned in the process of generating the text.

For example, as shown in FIG. 3, in embodiment 300, when a multimodal text generation request is received, the server may use a large language model 310 to process the prompt information 301 in the multimodal text generation request, and the large language model may generate a first decision information 320. The first decision information 320 includes a first indication information 321 indicating whether to search the first database.

The first database may be a database corresponding to a search engine or the like, which is not limited in the present disclosure. In this embodiment, the input of the large language model may include the prompt information 301 in the multimodal text generation request and the prompt information for prompting the large language model to generate a decision result of searching the first database. The prompt information for prompting the large language model to generate the decision result of searching the first database may be “Whether to search based on the text of the multimodal text generated based on the following prompt information?”

In an embodiment, if the first indication information indicates searching the first database, the first decision information 320 may further include a search statement 322, for example. Correspondingly, the prompt information for prompting the large language model to generate the decision result of searching the first database may further be used to prompt the large language model to generate the search statement. For example, the prompt information may be “Whether to search based on the text of the multimodal text generated based on the following prompt information. If a search is required, please provide a search statement.”

When the first decision information generated by the large language model 310 indicates searching the first database, in the embodiment 300, the large language model 310 may be used to call a calling interface corresponding to the first database 330 to perform a data search and generate a text information according to the search result. For example, the large language model 310 may generate text information by performing a retrieval-augmented generation task. For example, the search statement 322 may be used as an input of the large language model 310, the prompt information indicating the large language model to perform the retrieval-augmented generation task is also input into the large language model 310, and the large language model 310 performs the RAG task based on the search statement.

For example, in response to the input information including the prompt information indicating to perform the retrieval-augmented generation task, the large language model 310 may use the search statement 322 in the input information as an input parameter of the calling interface corresponding to the first database 330 based on an ability of the large language model 310 to call external tools. After the large language model 310 receives the searched information fed back by the calling interface, the large language model 310 may use the searched information to perform the generation of the text information 302 and output the generated text information 302.

For example, the process of using the large language model to perform the retrieval-augmented generation task may also be as follows: a search statement and a prompt information indicating the large language model to perform the search task are input into the large language model, and the large language model uses the search statement as an input parameter of the calling interface corresponding to the first database. The large language model may directly output the searched information after receiving the searched information fed back by the calling interface. Then, the output searched information and the prompt information in the multimodal text generation request may be used as an input of the large language model. The large language model performs the text generation task based on the input information, and outputs the text generated after performing the text generation task as the text information.

In an embodiment, as shown in FIG. 3, if the first indication information indicates not to search the first database, in this embodiment, the large language model 310 may directly perform the text generation task, so that the large language model 310 may generate the text information 302 based on the prompt information 301.

For example, the prompt information 301 may serve as the input information of the large language model 310, and the large language model 310 may process the prompt information 301. For example, the large language model 310 may perform a text prediction based on the prompt information 301 and output the predicted text as the generated text information 302.

In an embodiment, in a process of the large language model outputting the text information, the information input into the large language model may further include a prompt information indicating a format of the generated text information, so that the format of the text information generated by the large language model is more in line with actual desires. For example, the format of the text information may include a table format, a summary format, etc., which is not limited in the present disclosure.

For example, when no prompt information related to the task being performed is input, the large language model 310 performs the text generation task by default, that is, performs the text prediction based on the input information and uses the predicted text as the generated text.

In an embodiment, when the large language model generates the first decision information, the information input into the large language model may further include, for example, a prompt information indicating a decision rule, so that the large language model may generate a decision result based on the decision rule. For example, the decision rule may be “if the prompt information includes a name of an item that is updated quickly, such as a mobile phone, a search is required”. It is understandable that the above decision rule is merely used as an example to facilitate the understanding of the present disclosure. Any decision rules may be set according to actual desires, which is not limited in the present disclosure.

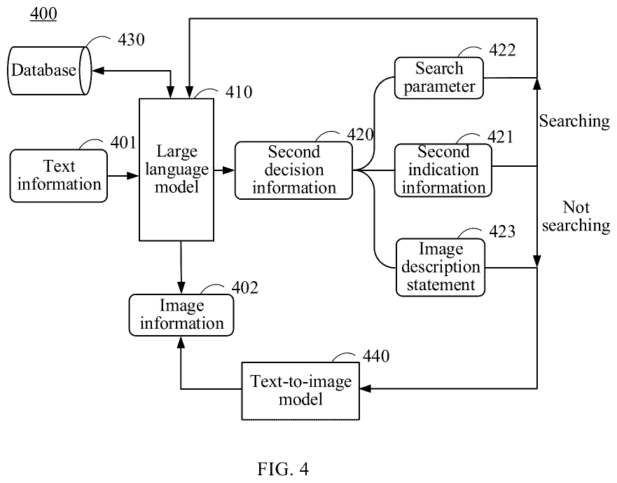

The principle of generating the image information is further expanded and described below with reference to FIG. 4. FIG. 4 is a schematic diagram showing a principle of generating an image information according to an embodiment of the present disclosure.

In an embodiment, when the image information is generated, for example, the large language model may be used to make a decision on whether to obtain the image through a search. When the decision is made to obtain an image through a search, the large language model performs an image search task to determine an image matched with the text information. In this way, the generated image information is obtained through a search, which may improve the timeliness, accuracy and/or authenticity of the obtained image information. This is because through a search, it is possible to search for highly timely and real information that a deep learning model such as the large language model has not learned. For example, if a real image (such as an image related to a certain film or TV series) matched with the text information exists, the searched image is usually more realistic than that generated by the deep learning model.

For example, as shown in FIG. 4, in embodiment 400, after the text information 401 is generated, the server may use the large language model 410 to process the text information 401, and then the large language model may generate a second decision information 420. The second decision information 420 includes a second indication information 421 that indicates whether to search a second database.

The second database may be an image database corresponding to a search engine, etc., which is not limited in the present disclosure. In this embodiment, the input information of the large language model may include the text information 401 and the prompt information for prompting the large language model to generate a decision result of searching the second database. The prompt information for prompting the large language model to generate the decision result of searching the second database may be “whether the image of the following text information can be obtained through a search”.

In an embodiment, when the large language model 410 generates the second decision information, the input information of the large language model 410 may further include the prompt information in the multimodal text generation request so as to increase the richness of the information referenced by the large language model when generating the second decision information, thereby improving the accuracy of the second decision information generated by the large language model.

In an embodiment, if the second indication information 421 indicates searching the second database, the second decision information 420 may further include a search parameter 422, for example. Accordingly, the prompt information for prompting the large language model to generate the decision result of searching the second database may further be used to prompt the large language model to generate a search parameter. For example, the prompt information may be “whether the image of the following text information can be obtained through a search? If the image can be obtained through a search, please provide a search parameter”.

When the second decision information generated by the large language model 410 indicates searching the second database, in embodiment 400, the large language model 410 may call a calling interface corresponding to the second database 430 to search for data, and then output the searched image as the image information 402.

For example, in response to the input information including the prompt information that indicates to perform the image search task, the large language model 410 may use the search parameter 422 in the input information as an input parameter of the calling interface corresponding to the second database 430 based on an ability of the large language model to call external tools. After the large language model 410 receives the searched image fed back by the calling interface, the large language model 410 may output the searched image as the image information 402.

In an embodiment, if the second indication information indicates not to search the second database, the second decision information 420 may further include an image description statement 423. The image description statement 423 may serve as a basis for generating the image. According to this embodiment, the large language model may directly perform the image generation task based on the image description statement 423, so that the large language model generates the image information.

In an embodiment, as shown in FIG. 4, when the second indication information 421 indicates not to search the database, the image description statement 423 may further serve as an input information of a text-to-image model 440, and the text-to-image model 440 performs the image generation task based on the image description statement 423, thereby generating the image information 402.

The text-to-image model 440 may include, for example, a model constructed based on a large language model, a steady-state diffusion model, or the like, which is not limited in the present disclosure. The text-to-image model 440 and the large language model 410 may form a system to provide the multimodal text generation function.

In an embodiment, when the large language model generates the second decision information, the information input into the large language model may further include, for example, a prompt information indicating a decision rule, so that the large language model may generate a decision result based on the decision rule. For example, the decision rule may be “if the text information involves real content, an image can be obtained through a search”, etc. It is understandable that the above decision rule is merely used as an example to facilitate the understanding of the present disclosure. Any decision rule may be set according to actual desires, which is not limited in the present disclosure. For example, if the text information is “generate an avatar for the Year of Dragon”, and the text information does not involve a real object, the second indication information in the second decision information indicates not to search the second database. If the text information is “stills of actor A in drama XX”, the second indication information in the second decision information indicates searching the second database.

According to embodiments of the present disclosure, the second decision information is generated by the large language model, and the image information is obtained by means of different methods based on different situations indicated by the second indication information in the second decision information. In this way, the diversity of the image information (reflected by the generated image information) may be improved, while the accuracy of the image information (reflected by the obtained image information through the search) may be ensured.

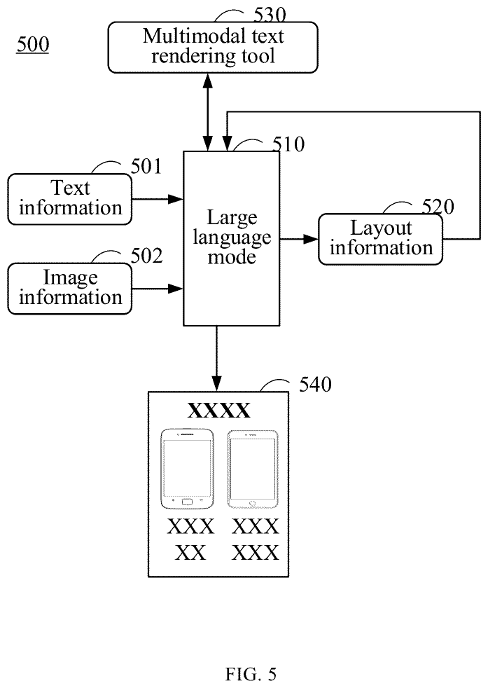

The principle of rendering the multimodal text is further expanded and described below with reference to FIG. 5. FIG. 5 is a schematic diagram showing a principle of rendering a multimodal text according to an embodiment of the present disclosure.

According to an embodiment of the present disclosure, before the multimodal text rendering tool is called to render the multimodal text, the large language model may generate a layout information of the multimodal text based on the text information and the image information. Then, the multimodal text is rendered based on the layout information. Compared with rendering the multimodal text with a fixed layout, rendering the multimodal text based on the layout information generated by the large language model may make the form of the multimodal text determined based on the content adaptability, which is conducive to improving the diversity and richness of the rendered multimodal text in content form.

As shown in FIG. 5, in embodiment 500, after the text information 501 and the image information 502 are obtained, the large language model 510 may perform a layout generation task based on the text information 501 and the image information 502, and the large language model 510 generates a layout information 520 for the multimodal text. And then, the large language model 510 may call a multimodal text rendering tool 530 based on the layout information 520 to render a multimodal text 540.

For example, an input information of the large language model 510 may be obtained based on the text information 501 and the image information 502. For example, the text information 501 and the image information 502 may be mapped to the same feature space and then concatenated, and the concatenated feature may be used as the input information. The large language model 510 may perform the layout generation task by processing the input information, so as to obtain the layout information 520. The layout information may include, for example, the position information of the bounding boxes of the text information 501 and the image information 502 in the multimodal text, and the position information of each bounding box includes an indication information to indicate the correspondence between the bounding box and the text information 501 or between the bounding box and the image information 502. For example, the indication information may indicate whether the bounding box corresponds to the text information or the image information.

In an embodiment, after the layout information 520 is obtained, the layout information 520, the text information 501 and the image information 502 may be used as the input of the large language model 510. The large language model uses the layout information 520, the text information 501 and the image information 502 as input parameters of the calling interface of the multimodal text rendering tool 530 based on an ability of the large language model 510 to call external tools, receives the multimodal text 540 fed back by the calling interface of the multimodal text rendering tool 530, and outputs the multimodal text 540 as output data of the large language model 510.

In an embodiment, when the large language model 510 performs the layout generation task, the input information of the large language model may also include an indication information indicating the large language model 510 to perform the layout generation task in addition to the text information 501 and the image information 502. The indication information may be, for example, “please generate a layout information of the multimodal text including the following text and images”, etc. It is understandable that the indication information is merely used as an example to facilitate the understanding of the present disclosure, which is not limited in the present disclosure.

In an embodiment, when the large language model 510 performs the layout generation task, the input information of the large language model may further include, for example, a predetermined size information of the multimodal text, and the size information may include, for example, the height and width of the multimodal text. In this way, the layout information generated by the large language model 510 may be more reasonable. The predetermined size information of the multimodal text may be adapted to, for example, a client application that presents the multimodal text, or may be adapted to a screen size of a terminal device that presents the multimodal text, or the like, which is not limited in the present disclosure.

In an embodiment, before the large language model calls the multimodal text rendering tool, it is possible to determine a background image information for the multimodal text based on the image information, for example. The background image information may be understood as a background image including the multimodal text. For example, according to this embodiment, the large language model may search for the background image information from a background image database based on the image information. For example, the color of the background image in the determined background image information is distinguishable from the color of the image in the image information, so as to improve the readability of the generated multimodal text. For example, the color of the background image in the determined background image information matches the color of the image in the image information. The matching between the two may refer to that the color schemes of the two meet predetermined color scheme matching conditions, thereby improving the aesthetics of the generated multimodal text.

In this embodiment, after the background image information is obtained, the large language model 510 may call the multimodal text rendering tool based on the layout information and the background image information. For example, the layout information, the background image information, the text information and the image information may serve as an input of the large language model. The large language model may use the layout information, the background image information, the text information and the image information as input parameters of the calling interface of the multimodal text rendering tool based on an ability of the large language model to call external tools, receive the multimodal text fed back by the calling interface of the multimodal text rendering tool, and output the multimodal text as output data of the large language model.

In this embodiment, the background image information is determined based on the image information, and the multimodal text is rendered based on the layout information and the background image information, so that the rendered multimodal text may meet the actual desires better, which is conducive to improving the readability and aesthetics of the rendered multimodal text.

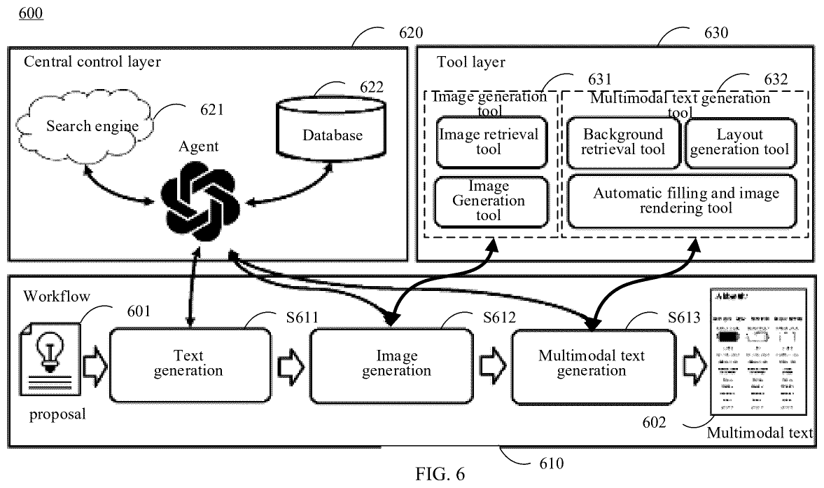

The following will describe the principle of the method for generating a multimodal text provided by embodiments of the present disclosure with reference to FIG. 6. FIG. 6 shows a system architecture diagram of a method for generating a multimodal text according to an embodiment of the present disclosure.

As shown in FIG. 6, the system architecture 600 for implementing the method for generating a multimodal text may include a layer 610 for implementing a workflow for multimodal text generation, a central control layer 620, and a tool layer 630. The workflow for the multimodal text generation includes operations S611 to S613 that are performed based on a large language model.

In operation S611, a text is generated. For example, the large language model generates a text information based on an input prompt information (proposal) 601. In the process of generating the text information, the large language model may generate the first decision information described above, and when the first decision information indicates searching a database, the large language model may act as an agent of a search engine 621 in the central control layer 620 to search for knowledge from a database 622. Then, the large language model may generate the text information based on the searched knowledge.

In operation S612, an image is generated. For example, the large language model may generate an image information based on the text information generated in operation S611. In the process of generating the image information, the large language model may generate the second decision information described above, and when the second decision information indicates searching a database, the large language model may call an image retrieval tool in an image generation tool 631 in the tool layer 630 to search the database 622 in the central control layer 620 as an agent, so as to search for the image information. When the second decision information indicates not to search the database, the system may call the image generation tool in the image generation tool 631 to generate the image information.

In operation S613, a multimodal text is generated. For example, the large language model may generate the multimodal text based on the text information generated in operation S611 and the image information generated in operation S612. In the process of generating the multimodal text, the large language model may call a layout generation tool (which may be referred to as the large language model itself) in the multimodal text generation tool 632 in the tool layer 630 to generate a layout information of the multimodal text, while the large language model may call a background retrieval tool in the multimodal text generation tool 632 to retrieve a background image information matched with the image information. And then, the large language model may call an automatic filling and image rendering tool (i.e., the multimodal text rendering tool) in the multimodal text generation tool 632 to perform rendering based on the background image information, the text information, the image information, and the layout information, so as to obtain a multimodal text 602.

In the system architecture 600, tools such as an image retrieval tool, an image generation tool, and a multimodal text generation tool are embedded in the whole system framework, and the large language model simulates the decision-making process as an agent. In the multimodal text generation process, the large language model generates an execution link that reflects a tool calling sequence, and calls corresponding tools one by one in sequence to generate the text information, the image information and the multimodal text, and then generates the multimodal text. The system architecture 600 may be applied to products such as a search engine to bring new knowledge to these products.

In the system architecture 600, by using the large language model as an agent, the overall control of the multimodal text generation process may be achieved, and the tools may be automatically scheduled to perform respective steps, so as to achieve the automatic generation of the multimodal text. Furthermore, by using the large language model as an agent, the large language model may learn an expression manner of a specific character, which may enable the generated multimodal text to be more realistic and greatly reduce the AI sense of the generated multimodal text. In addition, in the system architecture 600, the large language model supports access to a search engine, thereby effectively alleviating the problem of poor timeliness of knowledge learned by the model and enabling the generated multimodal text to be more timely.

In the system architecture 600, the large language model may perform a decision-making task, for example, the large language model may decide how to execute the next step in real time according to the actual situation, rather than performing step by step according to a fixed method or a fixed process. Therefore, different processes may be performed for different tasks, so as to improve the richness and diversity of the multimodal text content finally generated.

In an embodiment, in the process of generating the multimodal text, the method provided in the present disclosure may further include generating an information flow for the large language model, so as to reflect the input information and the output information of the large language model in the process of generating the multimodal text (for example, in each step of the execution link). For example, the information flow includes a plurality of sets of information, each set of information includes the input information and the output information of the large language model, and the plurality of sets of information are arranged in an order of the output information output by the large language model. For example, in an embodiment, the information flow may be expressed as: {prompt information, first decision information+search statement}, {search statement, text information}, {text information+prompt information, second decision information+search parameter}, {search parameter, image information}, {image information+text information, layout information}, {image information+text information+layout information, multimodal text}.

In this embodiment, after the information flow is generated, the generated information flow may be presented, so that the rationality of the information flow may be analyzed by the service personnel. If the information flow analyzed by the service personnel is reasonable, a selection operation may be performed on the information flow. The method according to this embodiment may further include determining the information flow as the target information flow in response to the selection operation on the information flow. The target information flow may serve as a sample for continuously optimizing the large language model to fine-tune the large language model based on the target information flow. In this way, the decision-making and information generation capabilities of the large language model may be continuously improved, and the quality of the generated multimodal text may be continuously improved.

In an embodiment, in addition to generating the information corresponding to the task performed by the large language model, the large language model may also generate a confidence level of the information which is generated by the large language model and corresponding to the task performed by the large language model, for example. Accordingly, when the large language model performs a task, the input information may further include, for example, a prompt information for prompting to output the confidence level of the generated information. For example, in the task of generating the text information, the input information of the large language model further includes a prompt information “Please provide the confidence level of the generated text information.” Alternatively, through training, the large language model may directly generate the confidence level without the prompt information for prompting to output the confidence level, that is, generating the confidence level is a default task of the large language model. It is understandable that in a case that the large language model generates at least one of the first decision information, the text information, the second decision information, the image information, the layout information or the multimodal text, the large language model may output a confidence level corresponding to the at least one of the first decision information, the text information, the second decision information, the image information, the layout information or the multimodal text.

In the case where the large language model further generates the confidence level, the method in this embodiment may further include comparing the confidence level corresponding to at least one information with a confidence level threshold. If the generated confidence level is less than the confidence level threshold, the method may return to the step of generating the at least one information using the large language model. That is, the large language model re-performs the task of generating the at least one information until the confidence level of the at least one information generated by the large language model is greater than or equal to the confidence level threshold. In this way, the large language model may have the ability to backtrack and reflect, which is beneficial to improving the quality and accuracy of the multimodal text finally generated, and may also avoid a failure of the multimodal text generation as much as possible.

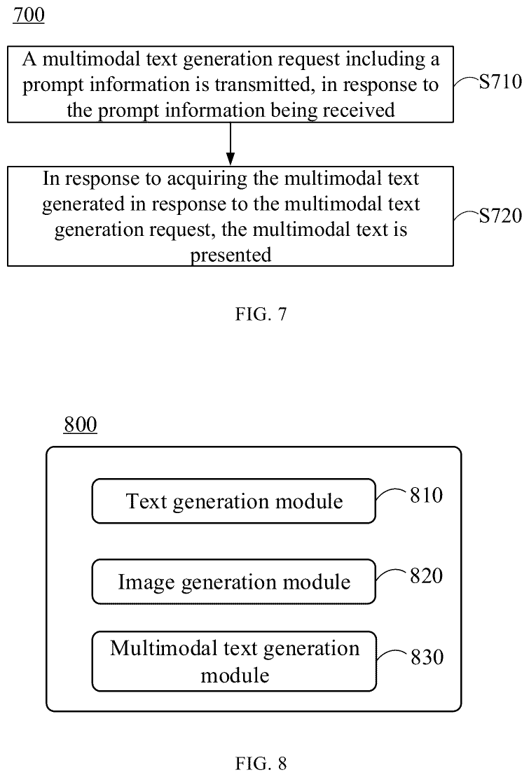

Based on the method for generating a multimodal text provided in the present disclosure, the present disclosure further provides a method for acquiring a multimodal text. The acquisition method will be described in detail below with reference to FIG. 7.

FIG. 7 shows a flow chart of a method for acquiring a multimodal text according to an embodiment of the present disclosure.

As shown in FIG. 7, the method for acquiring a multimodal text 700 in this embodiment may include operations S710 to S720.

In operation S710, in response to a prompt information being received, a multimodal text generation request including the prompt information is transmitted.

According to an embodiment of the present disclosure, the prompt information may be input into the terminal device by a user through an interactive interface provided by the terminal device. After the input prompt information is received, the terminal device may generate the multimodal text generation request including the prompt information and transmit the multimodal text generation request to a server. As described above, the prompt information may be a subject information of the multimodal text to be generated, a keyword of the multimodal text to be generated, or the like, which will not be described in detail here.

In operation S720, in response to acquiring a multimodal text generated in response to the multimodal text generation request, the multimodal text is presented.

The multimodal text is generated by using the method for generating a multimodal text described above. For example, after the multimodal text generation request is received, the server may generate a multimodal text using the method for generating a multimodal text described above and feed the multimodal text back to the terminal device. After the multimodal text is acquired, the terminal device may present the multimodal text.

By using the method for acquiring a multimodal text provided in the present disclosure, only the prompt information provided by the user may be required in the process of generating the multimodal text without performing other operations, which improves the degree of automation of the multimodal text acquisition and the user experience.

Based on the method for generating a multimodal text provided in the present disclosure, the present disclosure further provides an apparatus for generating a multimodal text. The apparatus will be described in detail below with reference to FIG. 8.

FIG. 8 shows a structural block diagram of an apparatus for generating a multimodal text according to an embodiment of the present disclosure.

As shown in FIG. 8, the apparatus for generating a multimodal text 800 in this embodiment may include a text generation module 810, an image generation module 820, and a multimodal text generation module 830.

The text generation module 810 is used to generate a text information corresponding to a prompt information using a large language model based on the prompt information, in response to a multimodal text generation request including the prompt information being received. In an embodiment, the text generation module 810 may be used to perform operation S210 described above, which will not be described in detail here.

The image generation module 820 is used to generate an image information corresponding to the text information using the large language model based on the text information. In an embodiment, the image generation module 820 may be used to perform operation S220 described above, which will not be described in detail here.

The multimodal text generation module 830 is used to call a multimodal text rendering tool using the large language model based on the text information and the image information to render the multimodal text including the text information and the image information. In an embodiment, the multimodal text generation module 830 may be used to perform operation S230 described above, which will not be described in detail here.

According to an embodiment of the present disclosure, the above text generation module 810 may include a first decision generation sub-module and a first text generation sub-module. The first decision generation sub-module is used to process the prompt information using the large language model to generate a first decision information. The first decision information includes a first indication information indicating whether to search a first database. In a case that the first indication information indicates to search the first database, the first decision information further includes a search statement. The first text generation sub-module is used to perform a retrieval-augmented generation task using the large language model based on the search statement to generate the text information, in response to the first indication information indicating to search the first database.

According to an embodiment of the present disclosure, the above text generation module 810 may further include a second text generation sub-module used to perform a text generation task using the large language model based on the prompt information to generate the text information, in response to the first indication information indicating not to search the first database.

According to an embodiment of the present disclosure, the above image generation module 820 may include a second decision generation sub-module and a first image generation sub-module. The second decision generation sub-module is used to process the input information using the large language model to generate a second decision information, where the input information is obtained based on the prompt information and the text information, and the second decision information includes a second indication information indicating whether to search the second database. In a case that the second indication information indicates to search the second database, the second decision information further includes a search parameter. The first image generation sub-module is used to perform an image search task using the large language model based on the search parameter to obtain the image information, in response to the second indication information indicating to search the second database.

According to an embodiment of the present disclosure, in a case that the second indication information indicates not to search the second database, the second decision information further includes an image description statement. The above image generation module 820 may further include a second image generation sub-module used to perform an image generation task using a text-to-image model based on the image description statement to generate the image information, in response to the second indication information indicating not to search the second database.

According to an embodiment of the present disclosure, the above multimodal text generation module 830 may include a layout generation sub-module and a rendering sub-module. The layout generation sub-module is used to perform a layout generation task using the large language model based on the text information and the image information to generate a layout information for the multimodal text. The rendering sub-module is used to call the multimodal text rendering tool using the large language model based on the layout information to render the multimodal text.

According to an embodiment of the present disclosure, the above apparatus for generating a multimodal text 800 may further include a background image determination module used to determine a background image information for the multimodal text based on the image information. The above rendering sub-module may be, for example, used to call the multimodal text rendering tool using the large language model based on the layout information and the background image information to render the multimodal text.

According to an embodiment of the present disclosure, an information generated by the large language model includes a generation information corresponding to a task performed by the large language model and a confidence level of the generation information. The generation information includes at least one of the text information, the image information, or the multimodal text. The apparatus for generating a multimodal text 800 may further include a calling module used to call a module for generating the generation information to re-perform a task of generating the generation information using the large language model, in response to a confidence level of the generation information being less than a confidence level threshold.

According to an embodiment of the present disclosure, the above apparatus for generating a multimodal text 800 may further include an information flow generation module, a present module, and an information flow determination module. The information flow generation module is used to generate an information flow for the large language model in a process of generating the multimodal text, and the information flow indicates an input information of the large language model and an output information of the large language model. The present module is used to present the information flow. The information flow determination module is used to determine the information flow as a target information flow, in response to a selection operation on the information flow. The target information flow is used to fine-tune the large language model.

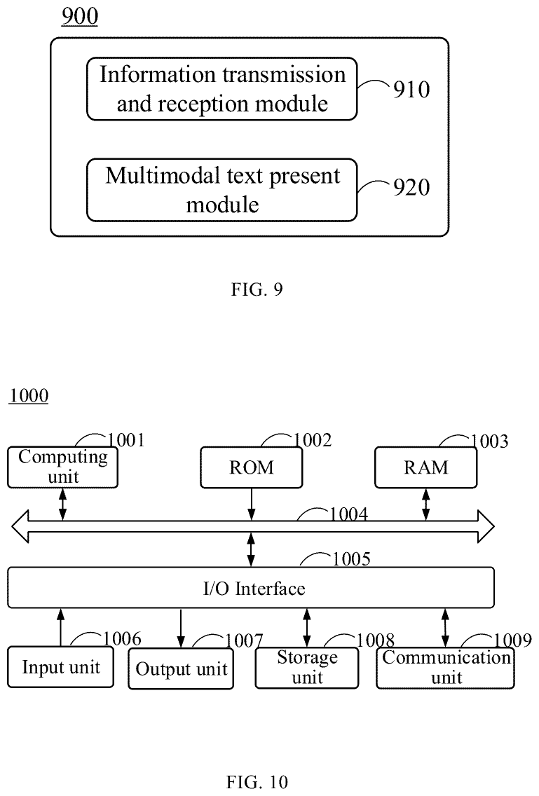

Based on the method for acquiring a multimodal text provided in the present disclosure, the present disclosure further provides an apparatus for acquiring a multimodal text. The apparatus will be described in detail below with reference to FIG. 9.

FIG. 9 shows a structural block diagram of an apparatus for acquiring a multimodal text according to an embodiment of the present disclosure.

As shown in FIG. 9, the apparatus for acquiring a multimodal text 900 in this embodiment may include an information transmission and reception module 910 and a multimodal text present module 920.

The information transmission and reception module 910 is used to transmit a multimodal text generation request including a prompt information in response to the prompt information being received. In an embodiment, the information transmission and reception module 910 may be used to perform operation S710 described above, which will not be described in detail here.

The multimodal text present module 920 is used to present the multimodal text in response to the information transmission and reception module acquiring the multimodal text generated in response to the multimodal text generation request. The multimodal text is generated using the apparatus for generating a multimodal text described above. In an embodiment, the multimodal text present module 920 may be used to perform operation S720 described above, which will not be described in detail here.

It should be noted that in the technical solutions of the present disclosure, the collection, storage, use, processing, transmission, provision, disclosure and application of user personal information involved are in compliance with the provisions of relevant laws and regulations, necessary confidentiality measures have been taken, and do not violate public order and good morals. In the technical solutions of the present disclosure, the user's authorization or consent is obtained before the user's personal information is obtained or collected.

According to an embodiment of the present disclosure, the present disclosure further provides an electronic device, a readable storage medium, and a computer program product.

FIG. 10 shows a schematic block diagram of an example electronic device 1000 for implementing the method for generating a multimodal text or the method for acquiring a multimodal text according to an embodiment of the present disclosure. The electronic device is intended to represent various forms of digital computers, such as laptops, desktops, workstations, personal digital assistants, servers, blade servers, mainframes, and other appropriate computers. The electronic device may also refer to various forms of mobile devices, such as personal digital assistants, cellular phones, smart phones, wearable devices, and other similar computing devices. The components shown herein, their connections and relationships, and their functions are only exemplary, and are not intend to limit implementations of the disclosure described and/or claimed herein.

As shown in FIG. 10, the device 1000 includes a computing unit 1001 that may perform various appropriate actions and processes based on a computer program stored in a read-only memory (ROM) 1002 or loaded from a storage unit 1008 into a random access memory (RAM) 1003. In the RAM 1003, various programs and data necessary for the operation of the device 1000 may also be stored. The calculation unit 1001, the ROM 1002 and the RAM 1003 are connected to one another via a bus 1004. An input/output (I/O) interface 1005 is also connected to the bus 1004.

A plurality of components in the device 1000 are connected to the I/O interface 1005, including: an input unit 1006, such as a keyboard and a mouse; an output unit 1007, such as various types of displays and speakers; a storage unit 1008, such as a disk and an optical disk; and a communication unit 1009, such as a network card, a modem, and a wireless communication transceiver. The communication unit 1009 allows the device 1000 to exchange information/data with other devices through a computer network such as the Internet and/or various telecommunication networks.

The computing unit 1001 may be a variety of general and/or special processing components having processing and computing capabilities. Some examples of computing unit 1001 include, but are not limited to, a central processing unit (CPU), a graphics processing unit (GPU), various dedicated artificial intelligence (AI) computing chips, various computing units running machine learning model algorithms, a digital signal processor (DSP), and any appropriate processor, controller and microcontroller. The computing unit 1001 performs the various methods and processes described above, such as a method for generating a multimodal text or a method for acquiring a multimodal text. For example, in some embodiments, the method for generating a multimodal text or the method for acquiring a multimodal text may be implemented as a computer software program, which is tangibly contained in a machine-readable medium, such as the storage unit 1008. In some embodiments, part or all of the computer program may be loaded and/or installed onto the device 1000 via the ROM 1002 and/or the communication unit 1009. When the computer program is loaded into RAM 1003 and executed by computing unit 1001, one or more steps of the method for generating a multimodal text or the method for acquiring a multimodal text described above may be performed. Alternatively, in other embodiments, the computing unit 1001 may be used to perform the method for generating a multimodal text or the method for acquiring a multimodal text in any other appropriate manner (e.g., by means of firm-wares).

Various implementations of the systems and techniques described above in the present disclosure may be realized in a digital electronic circuitry, an integrated circuitry, a field programmable gate array (FPGA), an application specific integrated circuit (ASIC), an application specific standard product (ASSP), a system on chip (SOC), a complex programmable logic device (CPLD), a computer hardware, a firmware, a software, and/or combinations thereof. These various embodiments may include being implemented in one or more computer programs that may be executed and/or interpreted on a programmable system including at least one programmable processor, which may be a special purpose or general purpose programmable processor that may receive data and instructions from a storage system, at least one input device, and at least one output device, and transmit data and instructions to the storage system, the at least one input device, and the at least one output device.

Program codes for implementing the methods of the present disclosure may be written in any combination of one or more programming languages. These program codes may be provided to a processor or controller of a general-purpose computer, a special-purpose computer or other programmable data processing device, so that when the program codes are executed by the processor or controller, the functions/operations specified in the flowcharts and/or block diagrams are implemented. The program codes may be executed entirely on the machine, partly on the machine, as a stand-alone software package, partly on the machine and partly on a remote machine or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus or device, or any suitable combination of the foregoing. More specific examples of machine-readable storage media would include electrical connections based on one or more wires, a portable computer disk, a hard disk, a random access memory (RAM), a read-only memory (ROM), an erasable programmable read-only memory (EPROM or flash memory), optical fibers, a portable compact disk-read-only memory (CD-ROM), an optical storage device, a magnetic storage device, or any suitable combination of the foregoing.

To provide interaction with a user, the systems and techniques described herein may be implemented on a computer having: a display device (e.g., a CRT (cathode ray tube) or LCD (liquid crystal display) monitor) for presenting information to the user; and a keyboard and pointing device (e.g., a mouse or trackball) through which the user may provide input to the computer. Other types of devices may also be used to provide interaction with a user; for example, the feedback provided to the user may be any form of sensory feedback (e.g., visual feedback, auditory feedback, or tactile feedback); and input from the user may be received in any form (including acoustic input, voice input, or tactile input).

The systems and techniques described herein may be implemented in a computing system that includes back-end components (e.g., serving as a data server), or a computing system that includes middleware components (e.g., an application server), or a computing system that includes front-end components (e.g., a user computer with a graphical user interface or web browser through which a user may interact with implementations of the systems and techniques described herein), or a computing system that includes any combination of such back-end components, middleware components, or front-end components. The components of the system may be interconnected by any form or medium of digital data communication (e.g., communication networks). Examples of the communication networks include a local area network (LAN), a wide area network (WAN), and the Internet.

A computer system may include a client and a server. The client and the server are generally remote from each other and typically interact with each other through a communication network. The relationship of client and the server arises by virtue of computer programs running on the respective computers and having a client-server relationship to each other. The server may be a cloud server, also known as a cloud computing server or cloud host, which is a host product in the cloud computing service system. It solves the defects of difficult management and weak business scalability in traditional physical hosts and VPS services (“Virtual Private Server”, or “VPS” for short). The server may also be a server of a distributed system, or a server combined with a block-chain.

It will be understood that various forms of the processes shown above may be used, with steps reordered, added or deleted. For example, the steps described in the present disclosure may be performed in parallel, sequentially, or in different orders, as long as the expected results of the technical solutions disclosed in the present disclosure may be achieved, which is not limited in the present disclosure.

The above specific implementations do not constitute limitations on the scope of protection of the present disclosure. It will be understood by those skilled in the art that various modifications, combinations, sub-combinations and substitutions may be made depending on design requirements and other factors. Any modifications, equivalent substitutions and improvements made within the spirit and principles of the present disclosure should be included in the scope of protection of the present disclosure.

What is claimed is:

1. A method for generating a multimodal text, comprising:
generating, by a large language model, a text information corresponding to a prompt information based on the prompt information, in response to a multimodal text generation request comprising the prompt information being received;
generating, by the large language model, an image information corresponding to the text information based on the text information; and
calling, by the large language model, a multimodal text rendering tool based on the text information and the image information to render the multimodal text comprising the text information and the image information.

2. The method according to claim 1, wherein the generating, by a large language model, a text information corresponding to a prompt information based on the prompt information comprises:
processing, by the large language model, the prompt information to generate a first decision information, wherein the first decision information comprises a first indication information indicating whether to search a first database, and in a case that the first indication information indicates to search the first database, the first decision information further comprises a search statement; and
performing, by the large language model, a retrieval-augmented generation task based on the search statement to generate the text information, in response to the first indication information indicating to search the first database.

3. The method according to claim 2, wherein the generating, by a large language model, a text information corresponding to a prompt information based on the prompt information further comprises:
performing, by the large language model, a text generation task based on the prompt information to generate the text information, in response to the first indication information indicating not to search the first database.

4. The method according to claim 1, wherein the generating, by the large language model, an image information corresponding to the text information based on the text information comprises:
processing, by the large language model, an input information to generate a second decision information, wherein the input information is obtained based on the prompt information and the text information, the second decision information comprises a second indication information indicating whether to search a second database; and in a case that the second indication information indicates to search the second database, the second decision information further comprises a search parameter; and
performing, by the large language model, an image search task based on the search parameter to obtain the image information, in response to the second indication information indicating to search the second database.

5. The method according to claim 4, wherein in a case that the second indication information indicates not to search the second database, the second decision information further comprises an image description statement, and
wherein the generating, by the large language model, an image information corresponding to the text information based on the text information further comprises:
performing, by a text-to-image model, an image generation task based on the image description statement to generate the image information, in response to the second indication information indicating not to search the second database.

6. The method according to claim 1, wherein the calling, by the large language model, a multimodal text rendering tool based on the text information and the image information to render the multimodal text comprising the text information and the image information comprises:
performing, by the large language model, a layout generation task based on the text information and the image information to generate a layout information for the multimodal text; and
calling, by the large language model, the multimodal text rendering tool based on the layout information to render the multimodal text.

7. The method according to claim 6, further comprising:
determining a background image information for the multimodal text based on the image information,
wherein the calling, by the large language model, the multimodal text rendering tool based on the layout information to render the multimodal text comprises:
calling, by the large language model, the multimodal text rendering tool based on the layout information and the background image information to render the multimodal text.

8. The method according to claim 1, wherein an information generated by the large language model comprises a generation information corresponding to a task performed by the large language model and a confidence level of the generation information, and the generation information comprises at least one of the text information, the image information, or the multimodal text; and
wherein the method further comprises:
re-performing, by the large language model, a task of generating the generation information, in response to the confidence level of the generation information being less than a confidence level threshold.

9. The method according to claim 1, further comprising:
generating an information flow for the large language model in a process of generating the multimodal text, the information flow indicating an input information of the large language model and an output information of the large language model;
presenting the information flow; and
determining the information flow as a target information flow, in response to a selection operation on the information flow,
wherein the large language model is fine-tuned with the target information flow.

10. A method for acquiring a multimodal text, comprising:
transmitting, in response to a prompt information being received, a multimodal text generation request comprising the prompt information; and
presenting the multimodal text, in response to acquiring the multimodal text generated in response to the multimodal text generation request,
wherein the multimodal text is generated by using the method according to claim 1.

11. An electronic device, comprising:
at least one processor; and
a memory communicatively connected to the at least one processor, wherein the memory stores instructions executable by the at least one processor, and the instructions, when executed by the at least one processor, are configured to cause the at least one processor to at least:
generate, by a large language model, a text information corresponding to a prompt information based on the prompt information, in response to a multimodal text generation request comprising the prompt information being received;
generate, by the large language model, an image information corresponding to the text information based on the text information; and
call, by the large language model, a multimodal text rendering tool based on the text information and the image information to render the multimodal text comprising the text information and the image information.

12. The electronic device according to claim 11, wherein the instructions are further configured to cause the at least one processor to at least:
process, by the large language model, the prompt information to generate a first decision information, wherein the first decision information comprises a first indication information indicating whether to search a first database, and in a case that the first indication information indicates to search the first database, the first decision information further comprises a search statement; and
perform, by the large language model, a retrieval-augmented generation task based on the search statement to generate the text information, in response to the first indication information indicating to search the first database.

13. The electronic device according to claim 12, wherein the instructions are further configured to cause the at least one processor to at least:
perform, by the large language model, a text generation task based on the prompt information to generate the text information, in response to the first indication information indicating not to search the first database.

14. The electronic device according to claim 11, wherein the instructions are further configured to cause the at least one processor to at least:
process, by the large language model, an input information to generate a second decision information, wherein the input information is obtained based on the prompt information and the text information, the second decision information comprises a second indication information indicating whether to search a second database; and in a case that the second indication information indicates to search the second database, the second decision information further comprises a search parameter; and
perform, by the large language model, an image search task based on the search parameter to obtain the image information, in response to the second indication information indicating to search the second database.

15. The electronic device according to claim 14, wherein in a case that the second indication information indicates not to search the second database, the second decision information further comprises an image description statement, and
wherein the instructions are further configured to cause the at least one processor to at least:
perform, by a text-to-image model, an image generation task based on the image description statement to generate the image information, in response to the second indication information indicating not to search the second database.

16. The electronic device according to claim 11, wherein the instructions are further configured to cause the at least one processor to at least:
perform, by the large language model, a layout generation task based on the text information and the image information to generate a layout information for the multimodal text; and
call, by the large language model, the multimodal text rendering tool based on the layout information to render the multimodal text.

17. The electronic device according to claim 16, wherein the instructions are further configured to cause the at least one processor to at least:
determine a background image information for the multimodal text based on the image information, and
wherein the instructions are further configured to cause the at least one processor to at least:
call, by the large language model, the multimodal text rendering tool based on the layout information and the background image information to render the multimodal text.

18. An electronic device, comprising:
at least one processor; and
a memory communicatively connected to the at least one processor, wherein the memory stores instructions executable by the at least one processor, and the instructions, when executed by the at least one processor, are configured to cause the at least one processor to implement the method of claim 10.

19. A non-transitory computer-readable storage medium having computer instructions stored therein, wherein the computer instructions are configured to cause a computer to at least:
generate, by a large language model, a text information corresponding to a prompt information based on the prompt information, in response to a multimodal text generation request comprising the prompt information being received;
generate, by the large language model, an image information corresponding to the text information based on the text information; and
call, by the large language model, a multimodal text rendering tool based on the text information and the image information to render the multimodal text comprising the text information and the image information.

20. A non-transitory computer-readable storage medium having computer instructions stored therein, wherein the computer instructions are configured to cause a computer to implement the method of claim 10.
